(19) United States
(12) Patent Application Publication
(10) Pub. No.: US 2006/0193966 A1
(43) Pub. Date: Aug. 31, 2006

(54) Multi-anion treated soy proteins and methods for preparation thereof

(76) Inventors: Shaowen Wu, St. Louis, MO (US); Richard Cheng Shen, Kirkwood, MO (US); Thomas L. Krinski, Granite City, IL (US)

Correspondence Address: SOLAE, LLC, PO BOX 88940, ST LOUIS, MO, 63188, US

(21) Appl. No.: 11/068,278

(22) Filed: Feb. 28, 2005

(51) Int. Cl. A23J 1/00

(52) U.S. Cl. 426/656

(57) ABSTRACT

Novel processes for treating soy proteins with multi-anionic reagents are disclosed. The processes include treating an acid precipitated soy protein curd with a multi-anionic species to modify the electrostatic charge on the protein molecules to improve functionality of the resulting soy protein containing composition when used in acidic environments. The resulting soy protein-containing composition has improved solubility, suspendability, and stability in acidic environments, and is highly suitable for use in acidic beverages. The processes may optionally include steps for using a stabilizing agent and for a phytase treatment to further improve the soy protein-containing composition.

### BACKGROUND OF THE INVENTION

The present invention is generally directed to modified soy protein-containing compositions and methods for producing modified soy protein-containing compositions utilizing multi-anionic species. More particularly, the present invention is directed to methods of producing modified soy protein-containing compositions having excellent stability, solubility, and suspendability in acidic solutions.

Proteins derived from soybeans have been utilized as an edible source of proteins for some time, and are commonly included in a number of consumer food items. Because these soy proteins have a number of functional properties, such as emulsifying and gel-forming properties, they have been widely used as a raw material in meat products, fishery paste products, side dishes, bread, confectionery products and acidic beverages, such as soft drinks and sport drinks. It appears that the usage of soy proteins in food items and acidic drinks will only increase in the future as it has now been recognized that soy proteins reduce blood cholesterol levels and provide excellent nutritional and physiological functions.

Although soy proteins have been used in a number of consumer edible goods and drinks, when utilized in acidic-type drinks, such as soft drinks, sports drinks, and health drinks, the solubility of the soy protein, and in particular the major soy storage proteins glycinin and beta-conglycinin, within the drink itself may limit the amount of soy protein that can be added. For example, in acidic drinks having a pH of less than about 5, the use of soy proteins may be significantly limited as the solubility of the soy protein is very low, and the proteins do not exhibit their functional properties. This is primarily due to the fact that the isoelectric point of many soy proteins is around a pH of about 3-5. This results in sedimentation problems in the beverages to which the soy proteins are added. Additionally, many acidic beverages to which soy proteins are added take on an undesirable astringent flavor.

To improve the solubility of soy proteins in acidic beverages and hence provide a consumer drink with an increased level of soy protein, several processes have been previously utilized. These processes have been mainly directed toward preventing the aggregation and/or precipitation of the proteins at a low pH. For example, some processes have added a stabilizer such as pectin or an emulsifier such as a sugar fatty acid having an HLB of 13 or more to improve the solubility of the soy proteins. Additionally, the solubility of soy proteins in acidic beverages has been improved by subjecting the soy proteins to enzymatic hydrolysis to cleave the proteins into smaller peptides that have improved solubility. Also, soy proteins have been chemically modified through succinylation to improve their solubility in the pH range of about 3 to about 5.

Recently, in U.S. Published Patent Application 2004/0086624, a process has been disclosed for improving soy protein solubility in an acidic environment through the use of an enzyme (e.g., phytase) in combination with chemical reagents (e.g., CaCl₂ and chitosan) to increase charges on the surface of the protein in aqueous solution. The process claims to improve the solubility and translucency of soy proteins at a pH of 3-4.5.

Although some of these approaches have generally increased solubility or stabilized soy proteins in acidic aqueous solutions, they have not solved the problem of providing an unhydrolyzed, substantially unhydrolyzed and/or unstabilized soy protein having good taste and improved aqueous solubility in acidic beverages and food systems. As such, a need exists in the industry for soy proteins, and processes for producing soy proteins, that exhibit improved solubility and taste in acidic solutions, such as acidic beverages.

### SUMMARY OF THE INVENTION

The present invention provides a soy protein-containing composition and processes for producing a soy-protein-containing composition that are suitable for inclusion in food and drink products, and specifically in acidic beverage products. The soy protein-containing composition has improved stability, suspendability, and solubility in acidic pH environments, including acidic beverages, as compared to conventional soy protein-containing compositions.

The processes described herein include conventional soy flake processing steps in combination with a novel process of mixing a multi-anionic species reagent with a precipitated soy protein curd to produce a modified precipitated soy protein slurry having improved functionality in acidic environments. The processes described herein can optionally include of number of steps including a phytase treatment to improve solubility in acidic environments and a stabilizing agent treatment to improve the taste of products utilizing the modified soy protein-containing composition described herein. Suitable multi-anionic reagents for use in the processes described herein may include polyvalent anions or alkaline earth metal salts of a polyvalent anion.

As such, the present invention is directed to a process for producing a soy protein-containing composition. The process includes first preparing a soy protein extract from soy flakes and then contacting the soy protein extract with an acid to produce a soy protein curd which is then contacted with a multi-anionic reagent to produce a modified soy protein slurry. This modified soy protein slurry is then heated at an acidic pH and spray dried to produce a soy protein-containing composition.

The present invention is further directed to a soy protein-containing composition comprising a soy protein. The composition comprises at least about 7000 ppm phosphorus and has an isoelectric point of greater than 4.

The present invention is further directed to a soy protein-containing composition comprising a soy protein. The composition has an isoelectric point of greater than 4 and is prepared by a process including a multi-anionic reagent treatment step.

### BRIEF DESCRIPTION OF THE DRAWINGS

FIG. 1 is a graph of the solubility as a function of pH for sodium hydrogen phosphate-treated soy proteins and a soy protein control.

FIG. 2 is a photograph of sodium hydrogen phosphate-treated soy proteins and a soy protein control wherein the pH is 3.8 and the samples and control have been sitting undisturbed for 24 hours.

FIG. 3 is a graph of solubility as a function of pH for sodium citrate-treated soy proteins.

FIG. 4 is a graph of solubility as a function of pH for sodium citrate and sodium hydrogen phosphate-treated soy proteins and a control.

FIG. 5 is a graph of solubility as a function of pH for a sodium hydrogen sulfate-treated soy protein and a control.

FIG. 6 is a graph of the overall charge of soy proteins for a control, a sodium phosphate-treated soy protein, a sodium citrate-treated soy protein, and a sodium sulfate-treated soy protein.

### DETAILED DESCRIPTION OF THE INVENTION

The present invention is generally directed to soy protein-containing compositions and processes for producing soy protein-containing compositions. The processes described herein include a step of treating a conventionally precipitated soy protein curd with a multi-anionic reagent to produce a modified soy protein slurry. Surprisingly, by treating the conventionally precipitated soy protein curd with the multi-anionic reagent, the resulting modified soy protein slurry exhibits substantially improved characteristics in food products, and specifically in acidic beverages. Notably, the resulting soy protein-containing composition has improved properties such as solubility, suspendability, stability, translucency, and flavor in acidic beverages.

As noted above, the processes of the present invention include a number of steps. The first steps of the processes include preparing a soy protein extract from a soy protein source, such as soy flakes, soy flour, etc, to produce a soy protein curd. As used herein, the term “soy flakes” is meant to include soy flakes, soy flour, and other common soy starting materials. One suitable extraction process for preparing a soy protein curd for use in the compositions described herein includes first cracking soybeans to remove the hull, rolling them into flakes with flaking machines, subjecting the flakes to a solvent extraction process, drying off the solvent to produce defatted white flakes, suspending the white flakes in a water solution, separating insoluble fiber from the soluble protein solution, and precipitating a soy protein curd therefrom with an acid. Suitable flaking machines may consist of a pair of horizontal counter-rotating smooth steel rolls. The rolls are pressed one against the other by means of heavy springs or by controlled hydraulic systems. The soybeans are fed between the rolls and are flattened as the rolls rotate one against the other. The roll-to-roll pressure can be regulated to determine the average thickness of the flakes. The rolling process disrupts the oil cell, facilitating solvent extraction of the oils from the flake. Specifically, flaking increases the contact surface between the oilseed tissues and the solvent (typically hexane or heptane as noted below), and reduces the distance that the solvent and the extract will have to travel in the extraction process as described herein below. Typical values for flake thickness are in the range of 0.2 to 0.35 millimeters.

The processed soy flake material may then be put through a solvent extraction process to remove oils therefrom. Typically, the solvent for the extraction process is a non-aqueous heptane or hexane solvent. The solvent removes materials soluble therein, including soybean oil and lecithins, and produces a defatted material.

Preferably the soy flake material is agitated in the solvent solution and then centrifuged for a period of time to facilitate removal of materials soluble in the solvent solution from the soy flake material. The solvent solution is then decanted from the soy flake material and goes through a solvent recovery step to generate oils. The recovered solvent solution is re-circulated through the extractor until the residual oil content in the soy flakes is reduced to the desired level.

Once the desired level of defatting has been obtained, the remaining solid material is generally dried to produce dried white flakes suitable for further processing. Conventional drying methods include hot air or steam drying.

Once the defatted white flakes are produced, they may optionally be suspended in a water solution to produce a suspended soy protein extract, sometimes referred to as a dispersion. Typically, the water solution comprises water having a temperature of about 90° F., although other solutions comprising water and other compounds and other temperatures conventionally known in the art may also be utilized. A centrifuge may optionally be utilized to remove any insoluble fiber from the soluble protein extract.

Finally, a soy protein curd is precipitated from the suspended soy protein extract with an acid. Precipitation removes remaining impurities, such as carbohydrates and fats, from the soy protein extract. Typically, the acid is hydrochloric acid (HCl), phosphoric acid, citric acid, sulfuric acid and combinations thereof and is used to produce a pH of about 4.0 to about 5.0 to form the precipitated soy protein curd. Other organic or inorganic acids may also be suitable and are well known to those skilled in the art. In a specific embodiment, phosphoric acid is used alone or in combination with citric acid to precipitate the curd at a pH of from about 3.5 to about 3.8.

In addition to preparing a precipitated soy protein curd as described above suitable for treatment with a multi-anionic reagent as described herein to modify the soy protein curd, some commercially available soy proteins are suitable for modification with multi-anionic reagents. The commercially available soy proteins are simply suspended in a water solution as described above and precipitated with an acid as described above to produce a precipitated soy protein curd suitable for modification. The commercially available soy proteins selected for multi-anion treatment are desirably unhydrolyzed, low solubility soy proteins. The commercially available soy proteins for acid beverage application generally have a molecular weight range of from about 18,000 Daltons to about 22,000 Daltons and a particle size distribution of from about 30 micrometers to about 50 micrometers (volume weighted mass). A suitable commercially available soy protein is XT-40 (The Solae Company, St. Louis, Mo.).

Once a suitable soy protein curd has been precipitated, it is generally introduced into water to form an aqueous protein slurry that is subsequently treated with the multi-anionic reagent described below. Generally, the aqueous protein slurry has a solids concentration of from about 5 wt. % to about 20 wt. % solids, desirably from about 8 wt. % to about 15 wt. % solids, and more desirably from about 10 wt. % to about 12 wt. % solids.

The pH of the aqueous protein slurry formed prior to the treatment with the multi-anionic species is generally adjusted to a pH of from about 2.5 to about 4.5. Desirably, the pH of the aqueous slurry is from about 2.5 to about 3.5, and more desirably from about 2.8 to about 3.2.

Treatment of precipitated soy protein curd (that is typically formed into a protein slurry as noted above) with a multi-anionic reagent produces a modified soy protein slurry having multi-anionic species associated with charged amino acid side chains contained on the surfaces of the proteins. The association of a positive ion with a negative ion is an electrostatic interaction. In the present case, negatively charged multi-anions associate with positively charged amino acid side chains (e.g., arginine and lysine). Due to the electrostatic interaction between multi-anions and charged sites on the protein surface, the multi-anion treatment results in the alteration of the overall surface charge of soy proteins present in the soy protein slurry. A change in the surface charge of the soy proteins results in a change in the isoelectric point (i.e., the pH where a molecule has a zero net charge) of soy proteins. Stated another way, the treatment of soy proteins with a multi-anionic reagent and the resultant surface charge alteration on the soy proteins affects the solubility and/or suspendability of the soy proteins at a particular pH by shifting the isoelectric point of the soy proteins. For example, when the isoelectric point of a soy protein is increased due to treatment with negatively charged multi-anionic species, the solubility of the multi-anion treated soy protein (i.e., modified soy protein) increases at lower pHs (generally highly acidic environments). In other words, the solubility of a multi-anion treated soy protein at pH 3.8 increases as the isoelectric point of the multi-anion treated soy protein increases from approximately 4 to a higher isoelectric point value.

Moreover, when comparing a multi-anion treated soy protein to a native soy protein at the same pH, an increase in the surface charge of the multi-anion treated soy protein results in the treated soy protein having a higher solubility. This is believed due in large part to the reduction of particle aggregation because of the repulsion of the greater surface charges on adjacent protein surfaces. Thus, multi-anion treatment of soy proteins results in a smaller average particle size that may average, for example, from about 15 to about 25 micrometers (volume weighted mass).

A variety of multi-anionic species (multi-anionic reagents) can be used to modify the precipitated soy protein curd. Generally, multi-anionic species suitable for modifying precipitated soy protein curd in accordance with the present invention have two or more ionizable groups capable of forming negative ions after ionization. For example, multi-anions comprising an alkali metal or alkaline earth metal salt of a polyvalent anion, and combinations thereof, are suitable multi-anionic species for use in the processes of the present invention.

Suitable multi-anionic species include, for example, sodium citrate, sodium hydrogen phosphate, sodium hydrogen sulfate, sodium dihydrogen phosphate, and the like, and combinations thereof. It is desirable that the multi-anionic species comprising the multi-anionic reagents posses a high affinity for positively charged ions on the protein surface. In one exemplary embodiment, a suitable multi-anionic reagent has three or more ionizable groups capable of forming negative ions after ionization. Without being bound by theory, it is believed that multi-anions having three or more ionizable groups have a greater affinity for the soy protein positive ions due to the greater charge potential of the trivalent or higher anions. One skilled in the art based on the disclosure herein will recognize that a multitude of other multi-anionic species may be suitable for use in the multi-anionic reagents described herein.

The treatment with the multi-anionic reagent is generally conducted for a time sufficient to impart the desired characteristics on the resulting soy protein composition. Generally, the multi-anionic reagent treatment is conducted for between about 1 minute and about 20 minutes, suitably from about 1 minute to about 10 minutes, and more suitably from about 5 minutes to about 10 minutes. Additionally, the multi-anionic reagent treatment is generally conducted at room temperature or at only slightly elevated temperatures. Generally, elevated temperatures are less preferred as these temperatures may modify the proteins in undesirable ways.

As noted above, the soy protein curd is generally introduced into an aqueous solution prior to treatment with the multi-anionic reagent. When this is done, the concentration of the multi-anionic reagent described above in the solution containing the soy protein curd is generally from about 0.1% (by weight of the soy protein curd) to about 5% (by weight of the soy protein curd), desirably from about 0.5% (by weight of the soy protein curd) to about 3% (by weight of the soy protein curd).

Generally, the solubility at low pH of the modified soy protein slurry increases with increasing concentration of the multi-anionic species up to an optimum multi-anionic concentration. Above this optimum concentration, the solubility at low pH of the modified soy protein slurry (or compositions resulting therefrom) decreases. In other words, the modified soy protein slurry can be “over-modified” to such an extent that it has undesirable solubility characteristics. Without being bound by theory, the decrease in solubility for the over-modified soy protein slurry may be due to the “salting out” of the soy protein as the solvent activity decreases with increasing multi-anionic concentration.

Once the modified soy protein slurry has been formed, it may optionally be heat treated to pasteurize the modified soy proteins to reduce bacteria growth and provide a soy protein-containing composition acceptable for use in food systems. Although typically done after modification, heat treatment of modified soy protein compositions of the present invention may occur before or after treatment of the soy protein curd with the multi-anionic species. Desirably, multi-anionic reagents are added to the aqueous soy protein prior to heat treatment. The temperature and duration of the heat treatment should be sufficient to pasteurize the modified soy protein mixture. Typically, pasteurization can take place at higher temperatures for shorter times or lower temperatures for longer times. In one suitable heat treatment method, the heat treatment process comprises heating in a vacuum at a temperature of 150° C. (300-305° F.) and a pressure of 500 psig for 9 to 15 seconds. In another embodiment, heating can be completed in a vacuum at 305° F. (152° C.) and 500 psig for 15 seconds. Generally, the pH of the solution during heat treatment is from about 2.5 to about 4.5, and suitably from about 2.8 to about 3.5.

Without being bound by theory, it is believed that modification of the soy protein curd with the multi-anionic species prior to heat treatment is desirable because when soy proteins are contacted with heat they unfold in three-dimensional structure. Upon cooling, the soy protein refolds and forms a new structure. By allowing the interaction of the multi-anionic species with a larger surface area on the protein during heat treatment, a larger portion of the soy protein may be contacted and form electrostatic interactions with multi-anionic species. After the addition of the multi-anionic reagent, it is believed that the negative charges on the surface of the proteins prevent the aggregation of multiple proteins together into larger agglomerations. By introducing additional negative charges into the proteins, repulsion is believed to be increased resulting in improved solubility.

The modified soy protein slurry is typically dried at some point after modification using a conventional drying process to produce a soy-protein containing composition. In one suitable embodiment, the modified soy protein slurry is dried by spray drying at a temperature of about 180° F. (82° C.) for a suitable period. The exact method and conditions used to dry the modified soy protein slurry is not critical, and one of many methods known to those skilled in the art is suitable. The spray drying produces a soy protein-containing composition with improved properties when utilized in acidic environments, such as in acidic beverages. The soy protein-containing compositions have improved suspendability, solubility, and stability in acidic environments. Also, with some embodiments described herein, translucency of the resulting product may be improved.

In an alternative embodiment of the processes of the present invention, a stabilizing agent may be utilized during the preparation of the soy protein-containing composition. A stabilizing agent added during the manufacturing of the soy protein-containing composition may interact with the globular structure of the proteins during the multi-anionic treatment and thereby increase suspension and solubility of these molecules and components when used in an acidic environment. Additionally, the stabilizing agent may also reduce or eliminate any astringency taste or other off-flavors.

Although the stabilizing agent can be introduced into the soy protein-composition manufacturing process at a number of points, it is generally introduced into the process at the same time as the multi-anionic reagent. As noted above, the stabilizing agent interacts with the globular surfaces of the proteins and other components. This interaction stabilizes the electrostatic interaction between molecules and components and thereby reduces the likelihood of the protein molecules aggregating together to form large aggregates, which have reduced solubility and stability in acidic environments. Typically, the pH of the soy protein curd to which the stabilizing agent is added is from about 2.5 to about 4.0, and desirably from about 2.8 to about 3.5. The stabilizing agent may be added in an amount of no more than about 20% (by weight of the protein curd), suitably no more than about 15% (by weight of the protein curd), and more suitably no more than about 5% (by weight of the protein curd).

Suitable stabilizing agents for use in the processes of the present invention include, for example, propylene glycol alginate, carboxymethylcellulose, guar gum, gum arabic, xanthan gum, and combinations thereof. Any one of these stabilizing agents can be used in a modified (i.e., hydrolyzed) or un-modified state. Preferred stabilizing agents include guar gum, gum arabic, and hydrolyzed guar gum.

In another embodiment of the present invention, the functionality of the soy protein-containing composition may be further improved for use at a pH of from about 3 to about 4.5 by utilizing an optional treatment for reducing the amount of phytin present during the manufacturing of the soy protein-containing composition. This treatment may improve the solubility, suspendability, and stability of the resulting soy protein-containing composition. Suitable examples of methods for reducing phytin include, for example, treatments with a membrane such as dialysis, ultrafiltration, and electrodialysis. Also, an ion exchange resin could be used. A preferred method for treating phytin includes the use of an enzyme or enzyme preparation having a phytic acid-hydrolyzing activity (phytase).

In an embodiment utilizing phytase, the functionality of the soy protein-containing composition is improved by treating the soy protein curd with phytase prior to, simultaneously, or after treatment of the soy protein curd with the multi-anionic species described above. The phytase treatment reduces the amount of phytin, an acid naturally found in soy proteins that can reduce the functionality of the soy protein when used in foods and food products, especially at low pH levels. Specifically, phytin has many sites of negative charge concentration and, as such, is able to have significant electrostatic interactions with more than one soy protein unit. The multiple interactions of phytin with soy protein units can cause large protein aggregates, therein reducing the solubility, stability, and suspendability of soy proteins in aqueous solutions.

Desirably, the phytase used in the treatment will not substantially hydrolyze the soy proteins as a high level of hydrolysis can lower the functional properties of the soy protein including, for example, gel forming capability, deterioration of taste due to an increase in low molecular hydrolysates, and the like. Conditions of the phytase treatment are not generally critical, and a method for reacting a phytase is not limited, although it is generally desirable to use a phytase with low or no protease activity to reduce the likelihood of hydrolysis of the protein.

The origin of the phytase enzyme or phytase enzyme preparation is not specifically limited so long as it has a sufficient phytic acid-hydrolyzing activity to be beneficial. Generally, a phytase derived from a microorganism is more advantageous than one derived from a plant in view of the prevention of hydrolysis and spoilage of the protein because the former has a higher phytic acid-hydrolyzing activity and a lower coexisting protease activity.

In one suitable embodiment, the phytase, in an amount of 0.1 to 100 units/gram, preferably 0.5 to 50 units/gram of the solid content, is reacted with the precipitated soy protein curd at a pH of 2.5 to 7.5 and a temperature of 20 to 70° C. for about 5 minutes to 3 hours. As used herein, one unit of a phytase activity represents the amount of an enzyme required for releasing 1 μmol of phosphoric acid from the substrate, phytic acid, during one minute of the initial stage of the reaction under standard conditions (i.e., pH 5.5, 37° C.). The exact parameters of the phytase treatment are not critical and suitable parameters can be determined by one skilled in the art.

The processes of the present invention described herein produce a soy protein-containing composition that has excellent functionality when utilized in an acidic environment, such as in an acidic beverage, where the pH is typically from about 3 to about 4.5, and more typically from about 3.2 to about 3.8. The soy protein-containing compositions have improved solubility, translucency, suspendability, and stability as compared to conventionally prepared soy protein-containing compositions in acidic environments, and do not produce significant sedimentation over an extended period of time. Stated another way, the soy protein-containing compositions produced by the processes of the present invention have isoelectric points that are higher than conventional soy protein-containing compositions. Because the isoelectric points are higher, the solubility and suspendability of the soy protein-containing compositions are higher at lower pHs resulting in desirable properties.

The soy protein-containing compositions of the present invention typically have an isoelectric point of greater than 4, and suitably greater than 4.1, 4.2, 4.3, 4.4, or even 4.5. With isoelectric points in this range, the solubility of the soy protein-containing compositions at a pH of about 3.2 to about 3.8 is significantly improved.

The soy protein-containing compositions of the present invention, as noted above, have improved solubility at low pHs as compared to conventional soy protein-containing compositions. Generally, the soy protein-containing compositions described herein have improved solubility over the pH range of from about 3 to about 4, and specifically from about 3.2 to about 3.8. In one specific embodiment, a soy protein-containing composition prepared in accordance with the present invention has solubility of greater than about 40% in water at a pH of 3.5. In another specific embodiment, a soy protein-containing composition prepared in accordance with the present invention has a solubility of greater than about 50% or even 70% in water at a pH of 3.7.

In addition to higher isoelectric points, some of the soy protein-containing compositions produced with the processes of the present invention have increased levels of phosphorus due to the treatment with the multi-anionic reagent. In one embodiment, the soy protein-containing composition has a concentration of phosphorus of at least about 7000 ppm.

### EXAMPLE 1

In this Example, three experimental soy protein-containing samples are produced using a process including treatment with a multi-anionic species as described herein. These three experimental samples are then evaluated for their solubility profile at a pH of 2-7 and for homogeneity at a pH of 3.8. Additionally, one control sample (commercially available XT-40 (Solae, LLC, St. Louis, Mo.) that is not subjected to the multi-anionic species process is also evaluated for solubility and homogeneity.

Each of the three experimental soy protein-containing samples is prepared on the bench top using soy protein curd precipitated with hydrochloric acid in a conventional manner as described herein the day before the treatment with the multi-anionic species and evaluation. The curd is produced via a counter current extraction with sodium hydroxide added to the second extraction and hydrochloric acid is used as the precipitating acid. The curd is chilled overnight. The precipitated curd is diluted to 10% (on a solids basis) in water and divided into the three experimental samples. Each of the three samples is then adjusted to a pH of 3.5 with hydrochloric acid. To the first experimental sample (Sample 1) is then added 5.0% (on a solids basis) of sodium dihydrogen phosphate. To the second experimental sample (Sample 2) is added 3.0% (on a solids basis) of sodium dihydrogen phosphate. To the third experimental sample (Sample 3) is added 1.5% of sodium dihydrogen phosphate. The control (XT-40 commercially available from The Solae Company, St. Louis, Mo.) is also diluted to 10% (on a solids basis) but did not have any dihydrogen phosphate added thereto. Samples 1, 2, and 3 are treated with the sodium dihydrogen phosphate for 10 minutes at room temperature.

The three experimental samples are then treated in a Microthermics unit with direct steam to a temperature of about 250° F. for about eight to nine seconds. The control is treated with direct steam to a temperature of about 250° F. for about 10.5 seconds. After the heat treatments, each of the three experimental samples and the control sample are screened (60 mesh) and spray dried in a Niro dryer.

The three experimental samples and the control sample are then functionally evaluated as follows: (1) solubility in acidic environment; and (2) homogeneity at a pH of 3.8.

The three experimental samples and control sample are first tested for their acid solubility at different pHs. The samples are tested for solubility at a pH of 3, 3.5, 3.8, 4.0, 4.5, 5.0, and 6.0 because of the particular interest in acidic beverages. The test method is as follows: For each sample, 0.48 grams of the sample is introduced into a 100 mL beaker along with 60.0 grams of water and stirred with a magnetic stirrer until a dispersion is obtained. Once the sample is dispersed, the pH of the aqueous solution is adjusted, with either dilute hydrochloric acid or dilute sodium hydroxide, to the desired pH for testing (i.e., 3, 3.5, 3.8, 4.0, 4.5, 5.0, or 6.0). Once the pH is adjusted, the beaker is introduced into a shaker bath and shaken at 100 cycles per minute for about 1 hour. After shaking, the pH of the sample is checked and, if necessary, adjusted back to the desired pH with either dilute hydrochloric acid or dilute sodium hydroxide. The sample is then shaken for an additional hour at 100 cycles per minute, regardless of whether the pH has to be re-adjusted.

After the shaking is completed, each sample is introduced, in the same amount, into centrifuge tubes and centrifuged for 10 minutes at 2000 rpm. After centrifuging, 1 mL of sample is removed from each tube and introduced into a labeled test tube. Into each tube containing the 1 mL of sample is introduced 4 mL of biuret solution and the mixture vortexed for a few seconds to mix. Each tube is then allowed to sit for thirty minutes to develop. A blank is also prepared which comprises 1 mL of deionized water and the biuret solution. After sitting, each tube is read in a spectrophotometer at 550 nm, and the amount of soluble protein calculated by subtracting the reading for the blank tube and dividing the reading for the sample by the reading for total protein and multiplying the result by 100.

Additionally, the three experimental samples and the control sample are evaluated for homogeneity, which measures the separation of isolate dispersions prepared with minimal blending and provides a means of judging the appearance of the prepared suspension. Ten grams of each experimental sample and the control are weighed out and introduced into distilled water (200 mL at 23° C.±5° C.) in a blender jar. Three drops of defoamer (Pegosperse) are added to each experimental sample and control and the pH of the liquid adjusted to 3.8 with hydrochloric acid. A blade assembly is then attached and each sample blended for 10 seconds on low speed in a standard blender. After 24 hours has passed, a photograph is taken of each sample for evaluation of the homogeneity.

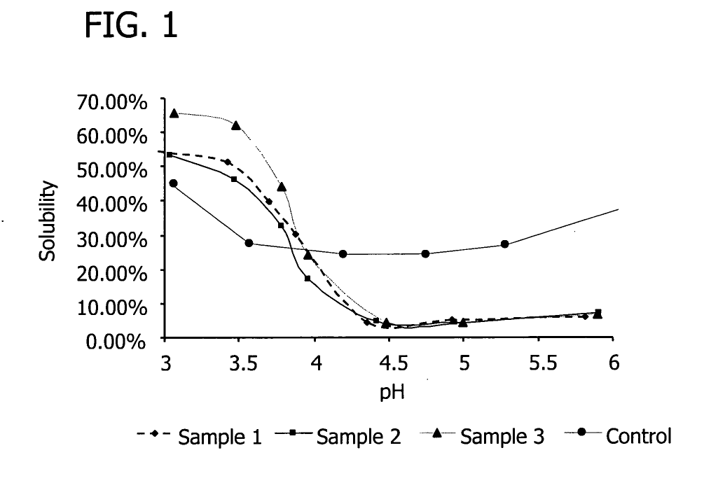

The results of the solubility profile are shown in FIG. 1. From this FIG. 1, it is easily seen that Sample 3 (1.5% treatment) is the most soluble over the acidic range of most interest, a pH of about 3.5 to about 4.0. Additionally, Samples 1 and 2 also show high solubility in the pH range of about 3.5 to about 4.0. Further, all three of the experimental samples are more soluble than the control at a pH of about 3.8. This data indicates that the multi-anionic treatment produces soy protein compositions with high solubility at low pHs.

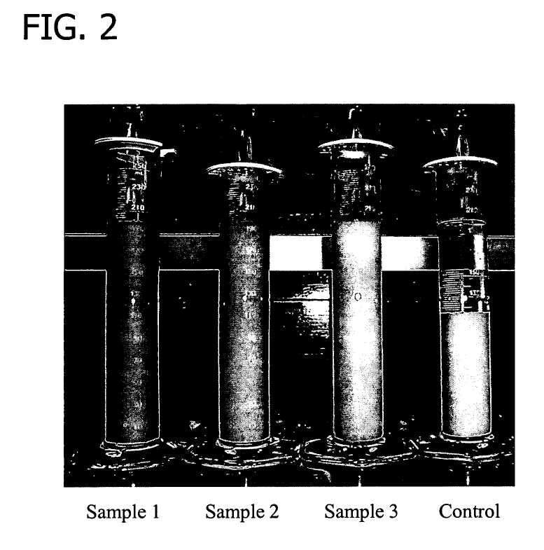

The results of the homogeneity evaluation at a pH of 3.8 are shown in FIG. 2. From the FIG. 2, it is seen that after 24 hours of standing undisturbed, the control sample has a clear top layer and a fluffy sediment. The three experimental samples are homogenous throughout the cylinder with no noticeable sedimentation. Based on this, the experimental samples perform much better regarding sedimentation as compared to the control when observed after 24 hours. There are no differences observed with regards to sedimentation with the three experimental samples.

From the data obtained in this Example, it is shown that the introduction of multi-anionic species into the three experimental samples increase the acidic solubility and homogeneity of the samples. The addition of 3.0% and 5.0% increase the solubility of the respective samples as compared to the control, but not as much as the 1.5% addition. Significantly, the three experimental samples treated with the multi-anionic species show no sedimentation after 24 hours, whereas the control shows significant settling.

### EXAMPLE 2

In this Example, four experimental soy protein-containing samples are produced using a process similar to that set forth in Example 1. These four experimental samples are then evaluated for solubility profile at a pH of 3-6 and for homogeneity at a pH of 3.8. Additionally, one control sample (commercially available XT-40 (Solae, LLC, St. Louis, Mo.) that is not subjected to the multi-anionic species process set forth in Example 1 is also evaluated for solubility and homogeneity.

The four experimental samples prepared are treated according to the process of Example 1 with a multi-anionic species as follows: (1) Sample 1: 1.23% Sodium Citrate; (2) Sample 2: 2.5% Sodium Citrate; (3) Sample 3: 4.9% Sodium Citrate; and (4) Sample 4: 1.0% sodium dihydrogen phosphate. The process as set forth in Example 1 is utilized with the exception that the four Samples are treated at a pH of 3.45 and heated to a temperature of 250° F. for 10 seconds. The control is prepared as set forth in Example 1.

Using the solubility profile test method of Example 1, Samples 1, 2, and 3 (each treated with Sodium Citrate) are evaluated for their solubility at a pH range of 3 to 6. Additionally, Samples 1 and 4 are compared with the control Sample over a pH range of from 3 to 6.

Additionally, using the homogeneity test method set forth in Example 1, the four experimental samples and control are evaluated for their homogeneity after 24 hours.

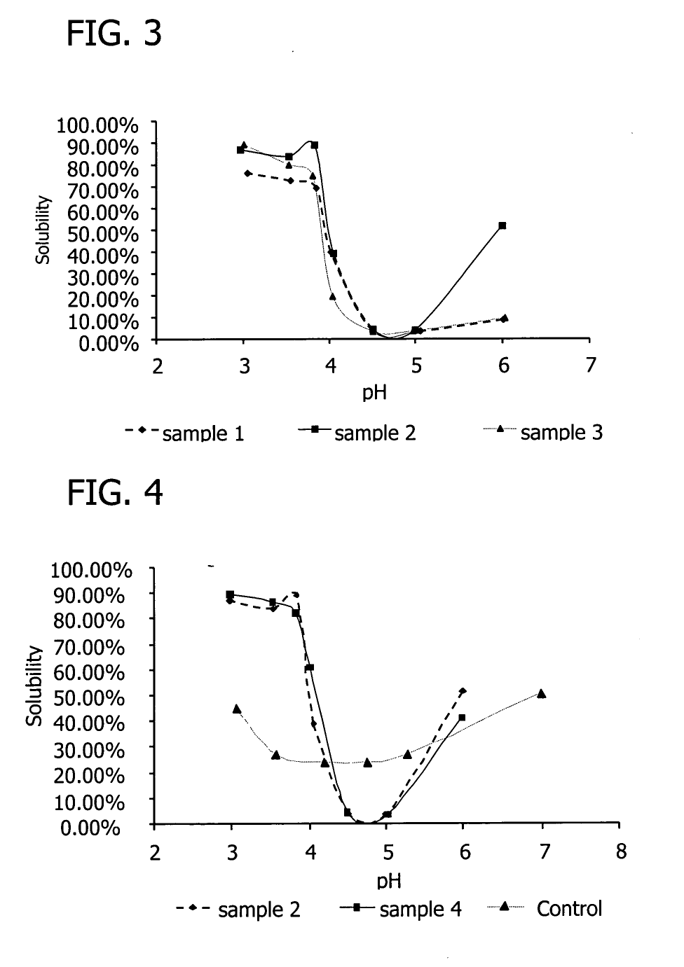

The results of the solubility profile for Samples 1, 2, and 3 (sodium citrate-treated Samples) are shown in FIG. 3. From this FIG. 3, it is easily seen that each of the experimental samples treated with sodium citrate display little difference in solubility in the pH range of 3-4. Each of the three Samples tested has very high solubility in this range.

The results of the solubility profile for Samples 1, 4, and the control are shown in FIG. 4. From this FIG. 4 it is seen that the sodium citrate treated sample and the phosphate treated sample are both significantly more soluble in the pH range of 3-4 as compared to the control. Experimental Samples 1 and 4 show similar solubility in this pH range. Of particular interest is the pH of 3.8, where the citrate treated sample and the phosphate treated sample are both over 80% soluble as compared to the control which is only 20%-30% soluble.

From the results of the homogeneity evaluation at a pH of 3.8, it is observed that after 24 hours of standing undisturbed, the control sample has a clear top layer and a fluffy sediment. The four experimental samples are homogenous throughout the cylinder with no noticeable sedimentation of marbling. Based on this, the four experimental samples perform much better regarding sedimentation as compared to the control when observed after 24 hours. There are no differences observed with regards to sedimentation with the four experimental samples.

### EXAMPLE 3

In this Example, an experimental soy protein-containing sample is produced using a process similar to that set forth in Example 1. This experimental sample is then evaluated for solubility profile at a pH of 3-6. Additionally, one control sample (commercially available XT-40 (Solae, LLC, St. Louis, Mo.) that is not subjected to the multi-anionic species process set forth in Example 1, is also evaluated for solubility.

The experimental sample prepared is treated according to the process of Example 1 with a sodium acid sulfate multi-anionic species (1.0% on a solids basis). The process as set forth in Example 1 is utilized with the exception that the sample is treated at a pH of 3.45 and heated to a temperature of 250° F. for 10 seconds. The control is prepared as set forth in Example 1.

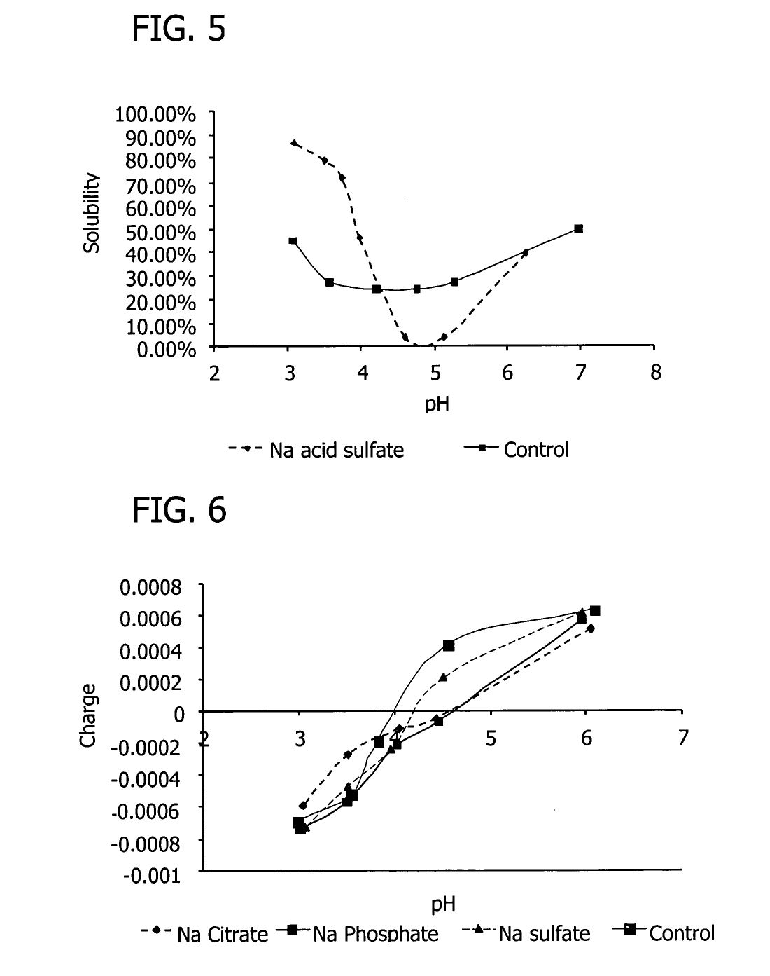

Using the solubility profile test method of Example 1, the experimental sample and control are evaluated for their solubility at a pH range of 3 to 6. The results of the solubility profile for the experimental sample and the control are shown in FIG. 5. From this FIG. 5, it is easily seen that the experimental sample treated with sodium acid sulfate has a significantly higher solubility as compared to the control in the pH range of 3-4.

### EXAMPLE 4

In this Example, Samples 1, 2, and 3 as prepared in Example 1 (i.e., the three soy protein-containing compositions prepared with a process including a multi-anionic treatment step) are introduced into two different acidic beverage models and the resulting beverages evaluated for stability after one month. The first acid beverage is based on 3.0 grams of either Sample 1, 2, or 3 from Example 1 in 8 ounces of beverage and the second acid beverage is based on 6.5 grams of either Sample 1, 2, or 3 from Example 1 in 8 ounces of acid beverage.

The acid beverages in which the Samples from Example 1 are tested include the following ingredients as set forth in Table 1 (First Beverage) and Table 2 (Second Beverage):

TABLE 1

| | | |
|---|---|---|
| Sample 1, 2, or 3 | 1.39 | grams |
| Sugar | 10.00 | grams |
| Apple Juice Concentrate* | 1.60 | grams |
| Natural Flavors | 0.2 | grams |
| Deionized Water | 86.81 | grams |
| Total | 100.00 | grams |

*Greenwood #APC418OJ3

TABLE 2

| | | |
|---|---|---|
| Sample 1, 2, or 3 | 3.00 | grams |
| Sugar | 10.00 | grams |
| Apple Juice Concentrate | 1.60 | grams |
| Natural Flavors | 0.2 | grams |
| Deionized Water | 85.2 | grams |
| Total | 100.00 | grams |

The first beverage and second beverage tested are made by dispersing the Sample protein in the deionized water with high shear for 5 minutes and heating to 66° C. for 10 minutes. To this protein slurry is added the rest of the ingredients and the pH adjusted, if necessary, to about 3.7 to about 3.9. Each beverage is then split into two samples and the first sample thermally processed at 102° C. for 30 seconds and cooled to 85° C. and the second sample thermally processes at 91° C. for 60 seconds. Both beverages are then cooled under tap water to 25-27° C. As such, a total of 12 beverages are made.

All of the beverages made in this Example are evaluated for suspension stability after one month. All 12 beverages that are made with the Samples from Example 1 show excellent stability, regardless of the concentration of the Sample (soy protein) and pasteurization temperature settings. After one month of storage, all 12 samples show virtually no sedimentation. The trace amounts of sedimentation present in some of the sample is easily and quickly shaken back into solution.

### EXAMPLE 5

In this Example, three experimental soy protein-containing samples are produced using a process similar to that set forth in Example I and are evaluated for their net ionic charge (also called particle charge distribution) at a pH of 3-6. Additionally, one control sample (native protein without any multiple anionic reagent) that is not subjected to the multi-anionic species process set forth in Example 1 is also evaluated for net ionic charge.

The three experimental samples prepared are prepared according to the process of Example 1 and treated with a multi-anionic species reagent as follows: (1) Sample 1: 2.5% Sodium Citrate; (2) Sample 2: 1.0% Sodium Dihydrogen Phosphate; and (3) Sample 3: 1.0% Sodium Acid Sulfate.

As noted above, the three experimental samples and the control sample are then tested for their particle charge distribution at different pHs. The samples and control are tested in a series of five titrations (pH 3, 3.5, 4, 4.5, and 6). The test method is as follows: For each sample and control, 5.0 grams is introduced into a 600 mL beaker along with 495 grams of deionized water and stirred with a magnetic stirrer until a dispersion is obtained. Once the protein material is dispersed in the water, the pH of the aqueous solution is adjusted, with either dilute hydrochloric acid or dilute sodium hydroxide, to the desired pH for testing (i.e., 3, 3.5, 4, 4.5, and 6).

Once the pH is adjusted, 10 grams of the aqueous dispersion are placed into a PTFE test vessel with Piston and Splash Guard, Part no. PCD 02-4. The PTFE test vessel is then mounted to a Mutek Particle Charge Detector PCD 02 (TMI Inc., Canada) The PCD is connected to a computer capable of running a titrator and evaluating the charges of the samples at the different titration pHs. Once the charges at the different testing pHs are determined, the isoelectric point of each sample is determined.

The results of the particle charge distribution analysis are shown in FIG. 6. From FIG. 6, it is seen that the charges of the control sample moved from anionic to cationic (i.e., isoelectric point) at a pH very near four. The charges of Sample 1 and Sample 2 moved from anionic to cationic around a pH of 4.5. Sample 3's charge distribution moved from anionic to cationic at a pH between 4 and 4.5. From the data obtained in this Example, it is shown that the introduction of multi-anionic species into the three experimental samples moved the isoelectric points of the samples to higher pHs as compared to isoelectric point of the control. This change in isoelectric point results in the multi-anionic species samples having increased solubility at lower pHs.

What is claimed is:

1. A process for producing a soy protein-containing composition, the process comprising:
preparing a soy protein extract from soy flakes by suspending the soy flakes in an extraction solution and centrifuging to produce the soy protein extract;
contacting the soy protein extract with an acid to form a soy protein curd;
contacting the soy protein curd with a multi-anionic reagent to produce a modified soy protein slurry;
heating the modified soy protein slurry at an acidic pH; and
spray drying the modified soy protein slurry to produce the soy protein-containing composition.

2. The process as set forth in claim 1 wherein the process additionally comprises the step of introducing into the modified soy protein slurry prior to the heating of the modified precipitated soy protein slurry a stabilizing agent.

3. The process as set forth in claim 2 wherein the stabilizing agent is selected from the group consisting of propylene glycol alginate, carboxymethylcellulose, guar gum, gum arabic, xanthan gum, and combinations thereof.

4. The process as set forth in claim 1 wherein the multi-anionic reagent contacting step additionally includes contacting the soy protein curd with phytase.

5. The process as set forth in claim 1 wherein the acid used to precipitate the soy protein curd is selected from the group consisting of hydrochloric acid, phosphoric acid, citric acid, sulfuric acid, and combinations thereof.

6. The process as set forth in claim 1 wherein the multi-anionic reagent is selected from the group comprising an alkali metal salt of a polyvalent anion, an alkaline earth metal salt of a polyvalent anion, and combinations thereof.

7. The process as set forth in claim 1 wherein the multi-anionic reagent is selected from the group consisting of sodium citrate, sodium hydrogen phosphate, sodium hydrogen sulfate, sodium dihydrogen phosphate, and combinations thereof.

8. The process as set forth in claim 1 wherein the multi-anion reagent is present during the contacting of the soy protein curd in an amount of from about 0.1% (by weight of the soy protein curd) to about 5% (by weight of the soy protein curd).

9. The process as set forth in claim 1 wherein the multi-anion reagent is present during the contacting of the soy protein curd in an amount of from about 0.5% (by weight of the soy protein curd) to about 3% (by weight of the soy protein curd).

10. The process as set forth in claim 1 wherein the process additionally comprises the step of introducing the soy protein curd into an aqueous solution before it is contacted with the multi-anion reagent.

11. The process as set forth in claim 10 wherein the pH of the aqueous solution is from about 2.5 to about 4.5.

12. The process as set forth in claim 10 wherein the pH of the aqueous solution is from about 2.5 to about 3.5.

13. The process as set forth in claim 10 wherein the pH of the aqueous solution is from about 2.8 to about 3.2.

14. The process as set forth in claim 1 wherein the modified soy protein slurry is heated at a pH of from about 2.5 to about 4.5.

15. The process as set forth in claim 1 wherein the modified soy protein slurry is heated at a pH of from about 2.8 to about 3.5.

16. A soy protein-containing composition comprising a soy protein, the soy protein-containing composition having an isoelectric point of greater than 4, wherein the soy protein-containing composition is prepared by a process including a treatment step comprising treating a precipitated soy protein curd with a multi-anionic reagent.

17. The soy protein-containing composition as set forth in claim 16 wherein the soy protein-containing composition has an isoelectric point greater than 4.2.

18. The soy protein-containing composition as set forth in claim 16 wherein the multi-anionic reagent is selected from the group consisting of sodium citrate, sodium hydrogen phosphate, sodium hydrogen sulfate, sodium dihydrogen phosphate, and combinations thereof.

19. The soy protein-containing composition as set forth in claim 16 wherein the treatment step comprising treating a precipitated soy protein curd with a multi-anionic reagent includes utilizing from about 0.1% (by weight of the precipitated soy protein curd) to about 5% (by weight of the precipitated soy protein curd) of the multi-anionic reagent.

20. The soy protein-containing composition as set forth in claim 16 wherein the treatment step comprising treating a precipitated soy protein curd with a multi-anionic reagent includes utilizing from about 0.5% (by weight of the precipitated soy protein curd) to about 3% (by weight of the precipitated soy protein curd) of the multi-anionic reagent.

21. A soy protein-containing composition comprising a soy protein and at least about 7000 ppm phosphorus, the soy protein-containing composition having an isoelectric point of greater than 4.

22. The soy protein-containing composition as set forth in claim 21 wherein the isoelectric point is greater than 4.2.

23. The soy protein-containing composition as set forth in claim 21 wherein the isoelectric point is greater than 4.4.
